(19) United States
(12) Patent Application Publication
(10) Pub. No.: US 2004/0153342 A1
(43) Pub. Date: Aug. 5, 2004

(54) Methods and apparatus for managing resident data

(76) Inventors: Alice E. Armintor, Houston, TX (US); Linda L. Lochli, Houston, TX (US)

Correspondence Address: BUCKLEY, MASCHOFF, TALWALKAR LLC, 5 ELM STREET, NEW CANAAN, CT, 06840, US

(21) Appl. No.: 10/354,786

(22) Filed: Jan. 30, 2003

(51) Int. Cl. G06F 17/60

(52) U.S. Cl. 705/3

(57) ABSTRACT

Methods and apparatus are provided for managing information relating to residents of senior housing residence facilities. In some embodiments, a distributed system manages resident information for a plurality of remotely located residence facilities. Contacts with residents and performance of tasks by facility employees may be reliably tracked using PDA's. Assessment data may be entered and processed to generate billing information in real time. Improved handling of life history data may be provided.

### FIELD

The present invention relates to systems and methods for managing information concerning residents of senior housing facilities.

### BACKGROUND

As the population of the United States ages, there is an increasing demand for senior housing facilities. In such facilities, residents rent living quarters, and meals are usually provided. In addition, many residents receive a greater or lesser degree of oversight or supervision, depending on the needs of the resident. The amount paid by each resident may vary depending on the level of care required by the resident.

Information management systems for senior housing facilities have been proposed, but have been limited in terms of the functions provided. The present inventors have recognized advantages to be gained by centralized management information systems which provide novel functions for senior housing facilities.

### SUMMARY

To alleviate problems inherent in the prior art, the present invention introduces improved systems and methods for managing information relating to residents of senior housing facilities.

According to one embodiment, a method of storing accession data includes performing a task relative to a resident. Accession data concerning the task is entered into a handheld data device, and the accession data is transferred from the handheld data device to a resident information storage system.

As used herein and in the appended claims, “accession” refers to a contact with a resident for the purpose of performing a task relative to the resident; and “handheld data device” refers to a device, such as a PDA (personal digital assistant), that fits the palm of a hand and stores data.

In some embodiments a time stamp may be associated with the accession data at the time the accession data is entered into the handheld data device.

According to another embodiment, assessment data is entered into a handheld data device, and the handheld data device is used to display billing information that is based on the assessment data.

According to still another embodiment, a respective care needs assessment is stored for each of a plurality of residents who reside in a residence facility, and a current revenue rate of the residence facility is estimated on the basis of the stored care needs assessments.

According to yet another embodiment, assessment data is stored relative to a resident, and the assessment data has an assessment date associated therewith. A reminder is automatically displayed to remind a user to reassess the resident. The reminder is displayed on a reminder date that is determined based on the assessment date.

According to a further embodiment, resident information is transmitted to a database from a first computer located at a first residence facility that is remote from the database. The first computer is also used to retrieve resident information from the database. In addition, resident information is transmitted to the database from a second computer located at a second residence facility that is remote from the database and from the first residence facility. The second computer is also used to retrieve resident information from the database.

According to still a further embodiment, data entries are received which represent at least one of a life history of a resident and one or more interests of the resident. At least some of the data entries are indicated by selection of respective menu items. Data which represents the received data entries is stored.

In some embodiments an activity calendar is generated for the resident based at least in part on the stored life history and/or interest data.

In some embodiments, such data entries are received for a plurality or all of the residents of a residence facility, and an activity calendar is generated for the residence facility based at least in part on the stored life history and/or interest data.

According to one embodiment, a handheld data device is configured to receive accession data concerning a task performed relative to a resident, and to transfer the accession data to a resident information storage system.

According to another embodiment, a handheld data device is configured to receive assessment data and to generate a care needs assessment based on the assessment data. The handheld data device is further configured to generate billing information on the basis of the care needs assessment.

According to still another embodiment, an apparatus includes a processor, and a storage device in communication with the processor and storing instructions adapted to be executed by the processor to: store a respective care needs assessment for each of a plurality of residents who reside in a residence facility, and estimate a current revenue rate of the residence facility on the basis of the stored care needs assessments.

According to yet another embodiment, an apparatus includes a processor, and a storage device in communication with the processor and storing instructions adapted to be executed by the processor to: store assessment data relative to a resident, and automatically display a reminder to reassess the resident, where the assessment data has an assessment date associated therewith, and the reminder is displayed on a reminder date determined based on the assessment date.

According to a further embodiment, an apparatus includes a central system that has a processor and a storage device in communication with the processor. The storage device stores a database. The apparatus further includes at least one first computer located at a first residence facility that is remote from the central system. The at least one first computer is configured to transmit resident information to the database and to retrieve resident information from the database. The apparatus further includes at least one second computer located at a second residence facility that is remote from the central system and from the first residence facility. The at least one second computer is configured to transmit resident information to the database and to retrieve resident information from the database.

According to still a further embodiment, an apparatus includes a processor, and a storage device in communication with the processor and storing instructions adapted to be executed by the processor to: receive data entries which represent at least one of a life history of a resident and one or more interests of the resident, and store data which represents the received data entries, where at least some of the data entries are indicated by selection of respective menu items.

According to yet a further embodiment, an apparatus includes a processor, and a storage device in communication with the processor and storing instructions adapted to be executed by the processor to: receive data entries which represent at least one of a life history and one or more interests with respect to each of a plurality of residents, store data which represents the received data entries, and generate an activity calendar for a residence facility in which the residents reside based at least in part on the stored data, where at least some of the data entries are indicated by selection of respective menu items.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a distributed resident information storage system according to some embodiments of the present invention.

FIG. 2 is a block diagram showing some details of a central system that is part of the resident information storage system of FIG. 1.

FIG. 3 is a flow chart which illustrates a process performed according to some embodiments of the present invention.

FIG. 4 is a flow chart which illustrates another process performed according to some embodiments of the present invention.

FIG. 5 is a flow chart which illustrates another process performed according to some embodiments of the present invention.

FIG. 6 is a flow chart which illustrates another process performed according to some embodiments of the present invention.

FIG. 6A is a screen display that may be provided in connection with the process of FIG. 6.

FIG. 7 is a flow chart which illustrates another process performed according to some embodiments of the present invention.

FIG. 8 is a flow chart which illustrates another process performed according to some embodiments of the present invention.

FIGS. 9-11 are screen displays that may be provided by some embodiments of the present invention.

### DETAILED DESCRIPTION

System Overview

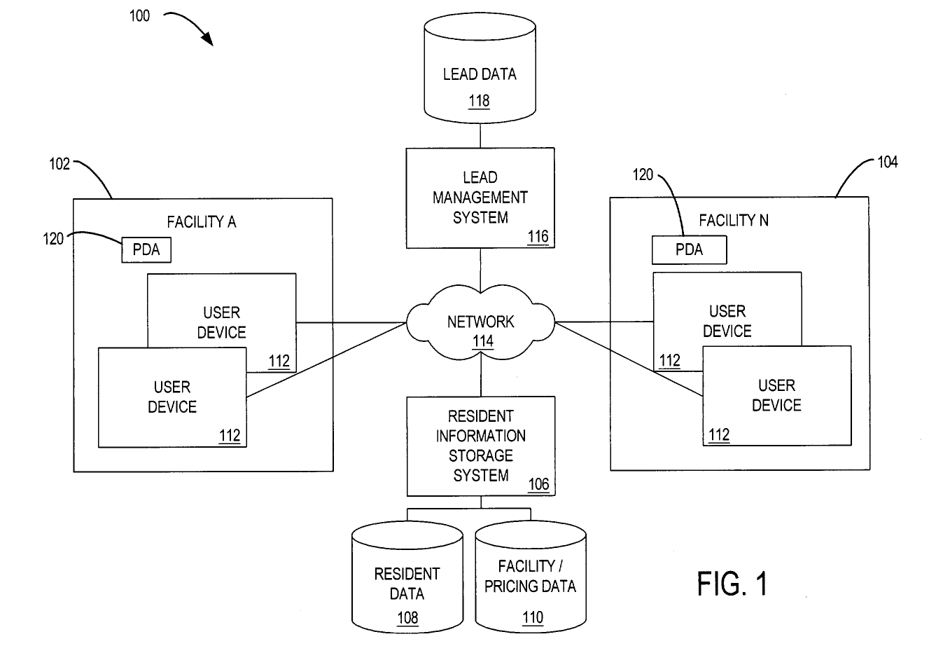

Turning now in detail to the drawings, FIG. 1 is a block diagram of a distributed resident information storage system provided according to some embodiments of the present invention. In FIG. 1, reference numeral 100 generally indicates the distributed system. The system 100 is provided to serve a plurality of senior housing residence facilities, of which two are schematically shown, namely Facility A (reference numeral 102) and Facility N (reference numeral 104), which is remotely located from Facility A. Although only two residence facilities are explicitly shown, it is contemplated that the system 100 of the present invention may encompass considerably more than two residence facilities.

The system 100 includes a central resident information storage system 106, which is remotely located from both residence facilities 102, 104. A resident database 108 and a facility/pricing database 110 are associated with the central system 106. (In some embodiments, the central system 106 may be located at one of the residence facilities which it serves.)

The system 100 also includes user devices 112, located at the residence facilities 102, 104. The user devices 112 may be, for example, personal computers and/or laptop or notebook computers. The user devices 112 are in data communication with the central system 106 via a data network 114. The data network 114 may be a private network, a public network such as the Internet, or a combination of public and private networks. If a public network is employed, the user devices 112 and the central system 106 may include encryption and decryption capabilities to protect the confidentiality of resident information transmitted via the data network 114. The data network may comprise, for example, a Local Area Network (LAN), a Metropolitan Area Network (MAN), a Wide Area Network (WAN), a proprietary network, a Public Switched Telephone Network (PSTN), a wireless network, and/or an Internet Protocol (IP) network such as the Internet, an intranet, or an extranet.

Also included in the system 100 is a lead management system 116, which is in data communication with the central system 106 via the data network 114. A sales lead database 118 is associated with the lead management system 116.

The system 100 may also include a number of handheld data devices such as PDA's 120 deployed at the residence facilities 102, 104. The PDA's may be constituted by conventional hardware (not separately shown) including a microprocessor, program and/or working memory associated with the microprocessor, and a touch-screen coupled to the microprocessor and employed to display data stored in the PDA and to receive input via a stylus or the like. Although only one PDA 120 is shown deployed at each residence facility, in practice a considerable number of PDA's may be provided at each residence facility. For example each resident care employee of the residence facility may be furnished with a PDA dedicated for use by the employee. At least some of the user devices 112 may be equipped with docking stations (not separately shown) by which the PDA's 120 may be interfaced to the user devices 112 to allow exchanges of data between the PDA's 120 and the user devices 112.

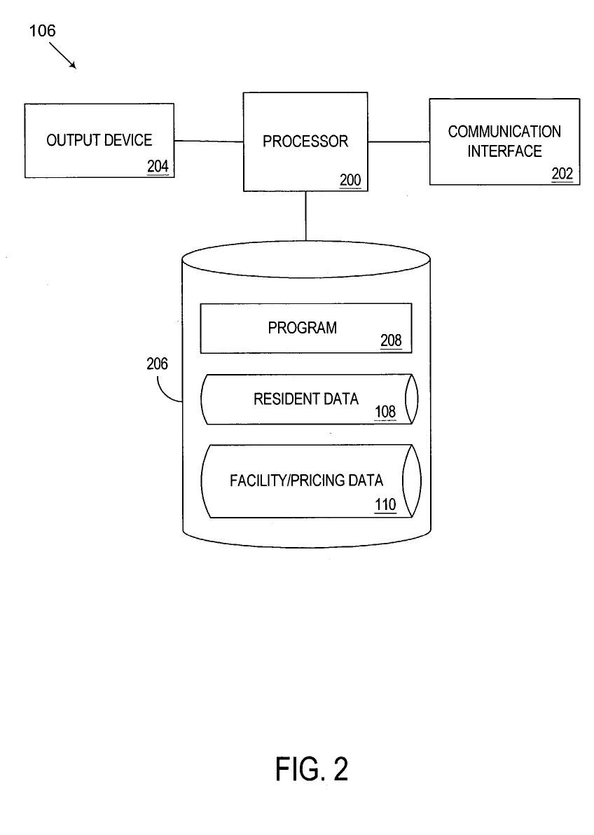

FIG. 2 is a block diagram which shows some details of the central system 106. The central system 106 includes a processor 200, which may be a conventional microprocessor. The processor 200 is in data communication with a communication interface 202, through which the central system 106 communicates with other components of the system 100, including the user devices 112 and the lead management system 116. The processor 200 is also in data communication with one or more output device(s) 204, which may include one or more displays and/or printers. (Although not shown in the drawing, the central system 106 may also include one or more input devices, such as keyboards and mice, in data communication with the processor 200.)

Also included in the central system 106 is a storage device 206, such as a conventional hard disk drive, in data communication with the processor 200. The storage device 206 stores a program 208 which is provided in accordance with the invention to control the processor 200 so that the central system 106 operates in accordance with one or more aspects of the present invention. Also stored in the storage device 206 are the resident database 108 and the facility/pricing database 110 referred to above.

The central system 106 may serve as a central repository for all information gathered or generated with respect to the residents who reside in the residence facilities served by the system 100. The resident data stored in the central system 106 may include personal and demographic data; information concerning family, personal and medical contacts for the residents; life history, leisure interest and preference information for the residents; care needs assessments and information upon which such assessments are based; and pricing and account information.

Information concerning prospective residents may first enter the system 100 as sales lead information entered into the lead management system 116. The sales lead information may identify the prospective resident by name, social security number, address, system identification number, family contacts, and so forth. When it is determined that the prospective resident will enter one of the residence facilities as a resident, sales lead information may be directly imported from the lead management system 116 into the central system 106 to form the basis of the data file for the resident. In some embodiments, the central system may be arranged such that a new resident file can be opened only by importing data from the lead management system, and the user devices 112 may be prevented from opening new resident files except through the lead management system.

In addition to storing and managing resident information, the central system 106 may store and manage other information for the residence facilities, such as expenses, accounts payable and other financial information, employee information, and billing accounts receivable information. Billing information may be imported from a resident information storage function of the central system 106 to a billing function of the central system. The central system 106 may be programmed to provide reports that are required by regulatory agencies. The central system 106 may also be employed to store and manage information pertaining to a corporate entity that owns or manages the residence facilities served by the system 100.

Functions Provided in Some Embodiments

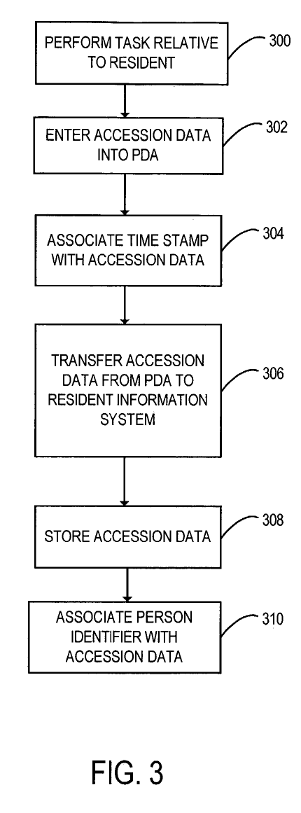

FIG. 3 is a flow chart that illustrates a process carried out in accordance with one aspect of the invention. At 300, an employee of a residence facility 102 or 104 performs a task relative to a resident. The task might be, for example, administering medication to the resident, helping the resident to dress or undress, helping the resident to bathe, reminding the resident that it is time for a meal, escorting the resident to an activity, and so forth. It will be appreciated that each of these activities involves an accession (i.e. a contact with the resident for the purpose of performing a task).

Next, at 302, the employee enters accession data into a PDA 120 carried by the employee. The accession data indicates the task performed by the employee and the resident's name. Then, at 304, the PDA automatically generates a time stamp and associates the time stamp with the accession data. The time stamp indicates the time at which the accession data is entered. The PDA may be arranged so that the employee cannot alter or interfere with the generation and storage of time stamps in association with accession data. As a result, the PDA verifies the times at which the employee enters accession data. This may make it difficult for employees to falsify record keeping in regard to care of residents, and may help to assure that resident care is performed promptly and reliably.

At 306, accession data is transferred from the PDA 120 to the resident information storage system 106. For example, the PDA may be docked (via a docking mechanism which is not shown) to a user device 112 and the accession data may be uploaded from the PDA to the user device. The docking of the PDA and the uploading of the accession data may occur at the end of the employee's working shift. Thus all of the accession data entered by the employee during his or her shift may be uploaded at once. The user device may store the uploaded accession data for a period of time and then upload the accession data to the resident information storage system 106, or the accession data may be immediately transferred to the resident information storage system upon docking the PDA to the user device.

The accession data transferred from the PDA to the user device and to the resident information storage system may include the time stamps associated with each entry of the accession data. The PDA may store data such as a person identifier that identifies the employee who carries the PDA, and this person identifier may also be transferred to the user device and to the resident information storage system with the accession data to identify the employee who performed the accessions. As another alternative, the PDA may store a PDA identifier (also referred to as a “device identifier”) which uniquely identifies the particular PDA and this identifier may be stored in the PDA and transferred to the user device and to the resident information storage system together with the accession data to identify the PDA which was used to enter the accession data. The user device and/or the resident information storage system may store a database that indicates which PDA's are assigned to which employees. On the basis of this information and the PDA identifier transferred by the PDA, the user device or the resident information storage system may determine the employee who performed the accessions. In either case, the resident information storage system stores the accession data transferred thereto (reference numeral 308) and associates with the stored accession data a person identifier that identifies the employee who performed the accession (reference numeral 310).

The process carried out in accordance with this aspect of the invention may make it easier and more convenient to keep records of contacts with residents and to assure accountability of residence facility employees. The time stamp, in particular, that is provided by the PDA may make it difficult for the employee to fabricate records of resident contacts and may help to ensure that employees perform their duties in a timely and thorough manner.

In some embodiments, the PDA may be programmed to present a list of tasks to the employee who carries the PDA. The list of tasks may include all tasks to be performed by the employee during the employee's shift. The list may specify the times at which the tasks are to be performed. The following is a simplified example of such a task list:

| | |
|---|---|
| 8:00 a.m. | give medications to Mr. Jones |
| 8:10 a.m. | help Ms. Smith get dressed |
| 8:25 a.m. | escort Ms. Gray to breakfast |
| | etc. |

The data for the task list may be downloaded to the PDA from one of the user devices 112.

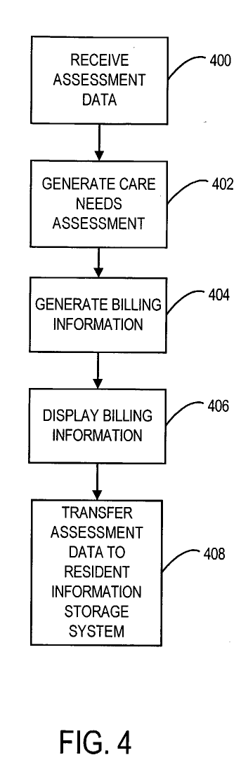

FIG. 4 is a flow chart that illustrates a process that may be performed in accordance with another aspect of the invention. At least some portions of the process of FIG. 4 may be performed with a PDA 120, with a user device 112, or with both used in combination.

At 400, assessment data is received by, e.g., a PDA 120. For example an employee of the residence facility may enter into the PDA data which is appropriate for making an assessment of a resident's need for care. The assessment data may be entered based on information that the resident and/or a family member provides during an interview conducted by an employee of the residence facility, and may be entered as the interview is taking place. The assessment data entered into and received by the PDA may indicate, for example, a number and/or types of medications that the resident is to take on a daily basis. In addition or alternatively, the assessment data may describe certain physical or health characteristics of the resident, such as whether the resident needs a wheel chair to travel to the dining room, or needs assistance getting into or out of bed or to take a bath. The PDA may be arranged so the assessment data may be entered by selecting menu items displayed by the PDA.

At 402, the PDA or user device, as the case may be, may generate a care needs assessment for the resident on the basis of the assessment data that was received at 400. The care needs assessment may take the form of a level of care that the residence facility will be required to provide to the resident. The care needs assessment may list the types of services that the residence facility will need to perform with regard to the resident each day and may include a number of minutes of staff time that will be required to perform the services. The number of staff time minutes required may be used (e.g., by the central system 106) to determine a necessary staffing level for the residence facility.

At 404, the PDA or user device may use data from a suitable database to generate billing information for the resident on the basis of the care needs assessment. The billing information may indicate a monthly amount to be paid by the resident. The monthly amount to be paid by the resident may vary depending on the level of care to be provided. The billing information generated at 404 may be displayed by the PDA or user device at 406. This may be done immediately after the entry of the assessment data, so that the resident and/or family member of the resident may be immediately informed of how much it will cost for the resident to reside in the residence facility.

At 408, one or more of the assessment data, the care needs assessment, and the billing information are transferred from the PDA and/or the user device to the resident information storage system (central system). The transferred information may include a resident identifier that indicates the resident to whom the transferred information is applicable. The billing information may be exported from the resident information storage system to a billing or financial information management system that handles billing to and payments from residents.

The assessment for the resident may be used to generate a care plan which indicates all tasks to be performed relative to the resident during each of three daily shifts. Instructions to residence facility staff may also be generated based on the assessment.

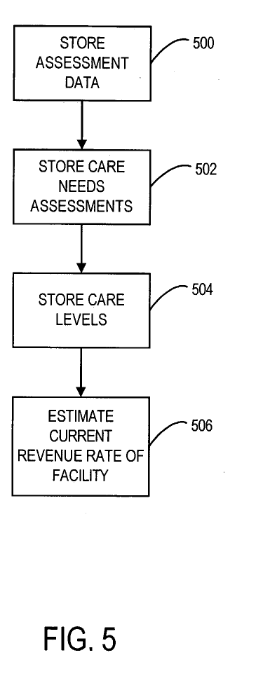

FIG. 5 is a flow chart that illustrates a process that may be performed according to still another aspect of the invention. At 500, assessment data may be stored in the resident information storage system 106 in, for example, the same manner as was described in connection with FIG. 4. This may be done for some or all of the residents of one of the residence facilities 102, 104. Similarly, as indicated at 502, care needs assessments may be stored in the resident information storage system for some or all of the residents of the residence facility in the same manner as described in connection with FIG. 4. Furthermore, as indicated at 504, levels of care to be provided to the residents may be stored in the resident information storage system. Alternatively, other methods of entering and storing assessment data, care needs assessments, and levels of care in the resident information storage system may be employed.

In any event, as indicated at 506, the resident information storage system may operate to estimate a current revenue rate for a residence facility 102 or 104 on the basis of all the stored care level information and/or care needs assessments for all of the residents of the residence facility. In this way, the resident information storage system may be used to obtain information on a daily basis, for example, to determine what is the current rate at which a residence facility can be expected to generate revenue. This may aid in managing the residence facility and in making decisions about staffing, expenditures and capital projects.

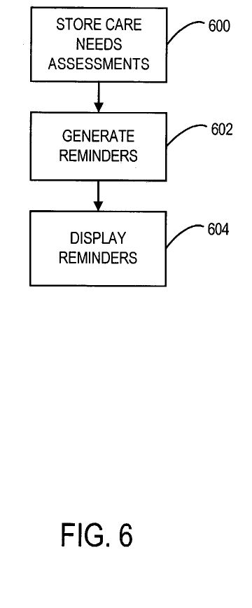

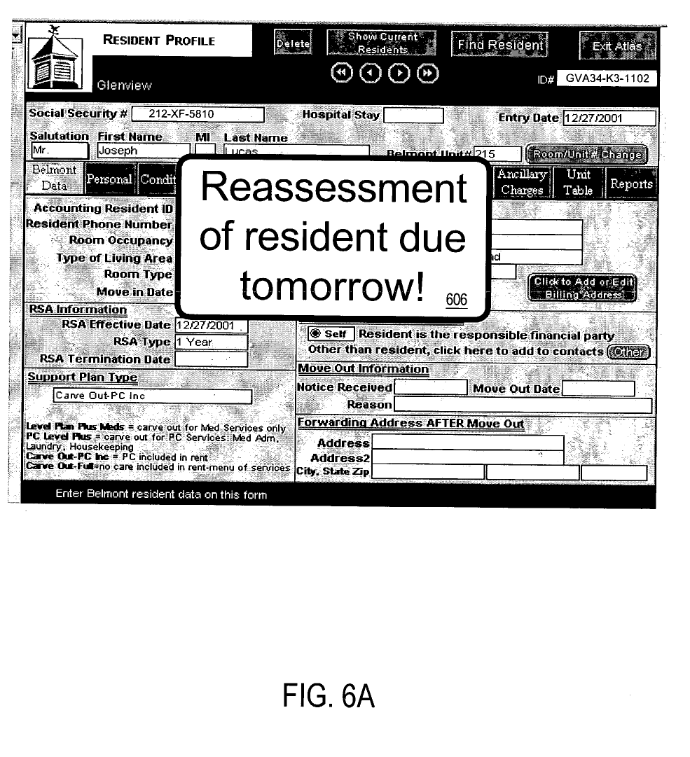

FIG. 6 is a flow chart that illustrates a process that may be performed in accordance with yet another aspect of the invention. At 600, care needs assessments may be stored in the resident information storage system for one or more residents. This may be done generally in the manner described in FIG. 4, with the understanding that each stored care needs assessment may have associated with it an assessment date that indicates an effective date of the assessment. As indicated at 602, the resident information storage system may operate to automatically generate reminders to reassess residents at predetermined times. The reminders may be displayed, as indicated at 604, on a display component of a user device 112 located at the residence facility for the resident to which the reminder pertains. Each reminder may be displayed, for example, in a pop-up window 606 (FIG. 6A), which may automatically appear superimposed on a screen display for the resident. In some embodiments, employees of the residence facility may check a profile screen of each resident each day, and the pop-up reminder 606 may appear superimposed on the profile screen of each resident when the time for reassessing the resident has arrived. In other embodiments, a list of reassessment reminders, identifying the relevant residents by name, may be automatically presented as a screen display (not shown) or a pop-up (not shown) when a supervisory employee logs into the resident information storage system each morning. In any case, the generation and displaying of reassessment reminders may occur on reminder dates that are determined at least in part based on assessment dates associated with the most recent assessments for the residents. In some embodiments, each resident may be assessed upon first entering the residence facility, and may be scheduled for reassessment 30 days after entering the facility and then at 90 day intervals thereafter. The process illustrated in FIG. 6 may aid in assuring that reassessments are carried out as scheduled. This may help to assure that residents are receiving proper levels of care, and that the residence facility is being properly compensated by the residents.

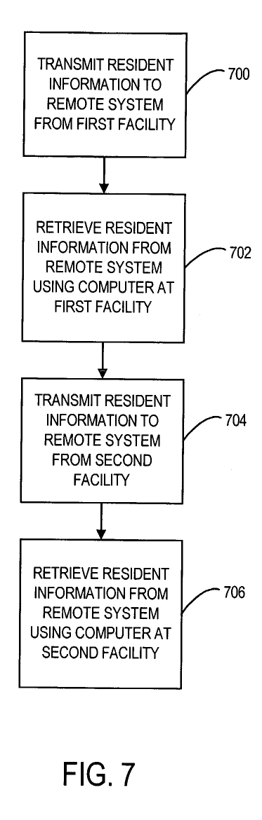

FIG. 7 is a flow chart that illustrates a process that may be performed in accordance with a further aspect of the invention. At 700, resident information is transmitted from one of the residence facilities (say facility A, reference numeral 102) to the resident information storage system 106 from a user device 112 that is located at the residence facility. It will be recalled that the user device 112 may be a personal computer. The resident information may include any information relevant to the resident and his or her residence at the residence facility. The resident information may include, for example, demographic information, contact information for family, friends, medical providers such as physicians, etc., of the resident, information about accessions to the resident, a care needs assessment and underlying assessment data, room number and billing rate, resident life history and interests, reports of incidents concerning the resident, resident health information, and so forth.

At 702, a user device such as a computer at the residence facility is used to retrieve resident information from the system 106. The information retrieved may include any type of resident information that was previously transmitted to or stored in the system 106.

At 704, resident information is transmitted from another one of the residence facilities (say facility N, reference numeral 104) to the resident information storage system 106 from a user device 112 (which again may be a personal computer) that is located at the other residence facility. The resident information may include, for example, any of the types of resident information described in conjunction with 700.

At 706, a computer (e.g., a user device 112) at the other residence facility is used to retrieve resident information from the resident information storage system 106. Again the information retrieved may include any type of resident information that was previously transmitted to or stored in the system 106.

Recalling that the residence facilities 102, 104 and the system 106 may all be located remotely from each other, it will be recognized that the overall system 100 functions as a distributed system in which resident information management needs for plural residence facilities (which may be commonly owned) are handled by one central system. This represents an advance over prior art resident information systems, which were limited in their capabilities to serving a single residence facility. The distributed system of the present invention allows for improved service to the residence facilities, economies of scale, and more sophisticated data processing support as compared to prior art systems. The distributed system of the present invention also may allow for improved management oversight.

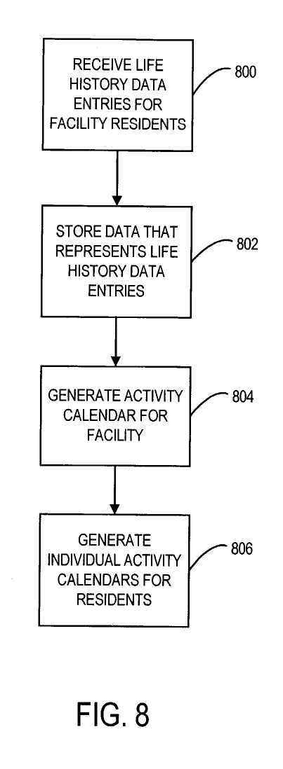

FIG. 8 is a flow chart that illustrates a process that may be performed in accordance with yet a further aspect of the invention. At 800, a PDA 120, a user device 112 and/or the resident information system 106 receives life history data entries for facility residents. The life history data entries may be based on information provided by residents in one-on-one interviews with residence facility employees. The employees may enter at least some of the life history data by selecting certain menu items displayed by, e.g. a user device 112. The life history entries may provide information about residents concerning their occupations, professions (or former occupations or professions), places where they have lived or to which they have traveled, the numbers and ages and occupations of their children, names and/or types of organizations of which they are or have been members, and so forth. To give one example, one life history data entry may be made by selecting an item from a menu which lists: “manager”, “supervisor”, “doctor”, “accountant”, “teacher”, “lawyer”, “insurance agent”, etc. as possible choices.

In addition or alternatively, data entries may be received at 800 that represent one or more interests of the residents. Entries of this type may, for example, be indicated by selecting one or more items from a menu which contains items such as: “books”, “music”, “sports”, “art”, “museums”, etc. Selection of one of these items may result in a submenu being displayed which presents more precise areas of interest within the areas of interest indicated by the main menu item. For example, selecting “books” may cause a submenu to pop up with items such as “fiction”, “poetry”, “nonfiction”, etc. Selection of a submenu item may cause a sub-submenu to pop up. For example, selecting “nonfiction” might yield a sub-submenu having items such as “history”, “biography”, “technology”, “economics”, etc.

To give other examples of submenus, selecting “music” from the main menu may yield a submenu with items such as “classical”, “jazz”, “folk”, etc. Selecting “sports” may yield a submenu such as “baseball”, “football”, “basketball”, “hockey”, etc.

At 802, data that represents the life history and/or interests data entries is stored in, for example, the system 106 and/or a user device 112. Because some or all of the life history and/or interest data has been entered by selection of menu items, it may be possible to sort, tabulate, categorize and classify the data. This may make it feasible to automatically generate (reference numeral 804) a suitable activity calendar for the residence facility based on the interests, preferences and/or life histories of the residents of the residence facility. In this way programs and activities may be selected that are likely to be of interest to a considerable number of the residents. It is also contemplated that a residence facility activity calendar may be compiled manually based on the stored life history and/or interest data, and/or based on a computer compilation of such data.

Furthermore, as indicated at 806, individual activity calendars may be generated, automatically or manually, for particular ones of the residents, on the basis of the life history and/or interest data that has been entered for the particular residents.

The life history and/or interest data entered and stored in accordance with this aspect of the invention may permit a residence community to improve its responsiveness to the social and intellectual needs and preferences of residents, in a way that was not possible with prior art systems in which life history data, if present at all, was stored as a flat file. With the process of FIG. 8, machine intelligence and data manipulation capabilities may allow residence facility programs and activities to be matched, or to be matched with greater precision and responsiveness, to the preferences of residents.

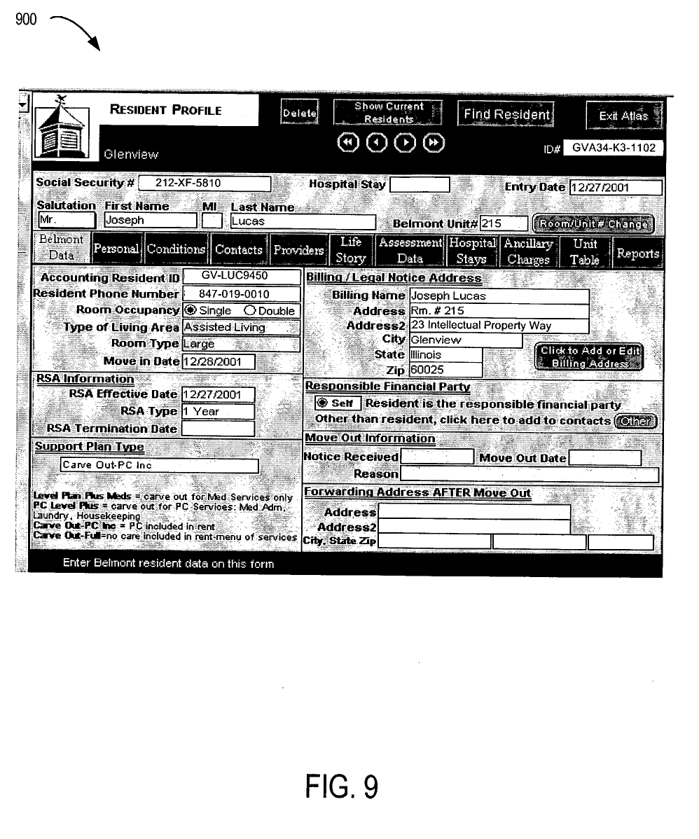

FIGS. 9-11 are examples of screen displays that may be provided via display components of user devices 112 of the system 100 in some embodiments of the invention. For example, FIG. 9 is a basic information or “profile” screen which shows basic information about a resident and terms of his or her residence in the residence facility. Various virtual “buttons” 900 allow a user of the system to navigate to other screens that display other types of information about the resident.

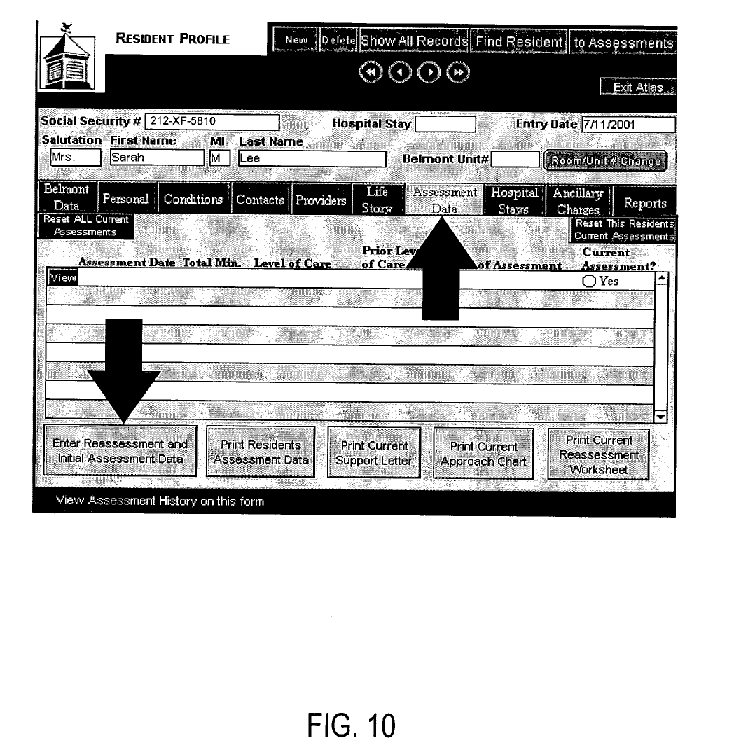

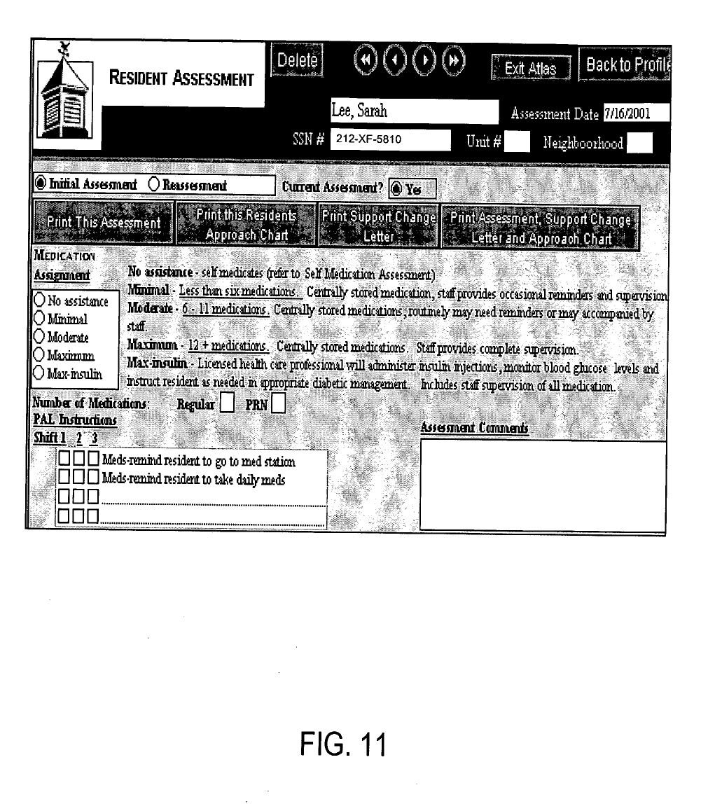

FIG. 10 is a screen display that may be invoked to view information about a care needs assessment for the resident. From the screen of FIG. 10, a user may navigate to the screen display shown in FIG. 11, which may be used to enter information for performing an initial assessment or a reassessment of a resident.

Other screen displays, which are not shown, may display information concerning addresses and phone numbers of the resident's family, friends and/or physicians; information about the resident's health care providers; life story and interests data; information about hospital stays by the resident; additional amounts that may be chargeable to the resident beyond the basic monthly charge, and so forth. Those of ordinary skill in the art will recognize from the above disclosure and from the appended drawings still other types of screen displays that may be provided in embodiments of the invention.

Another screen display, which is not shown, may allow the user to select from among a number of reports that may be printed. In some embodiments, the reports may include:

A census and occupancy report which indicates how many residents are generating revenue, and how many residents are physically in the facility;

A health and reassessment report, which indicates which residents are due for reassessment, what billing charges are applicable to each resident, and which residents are self-medicating;

A “face sheet” which is a document to be provided to an emergency medical technician when the technician is called to care for a resident; the face sheet indicates medical information about the resident;

An “approach chart” which guides residence facility employees as to the care plan in effect for a resident;

Miscellaneous other reports that may indicate information about a resident such as birthday, telephone number, religion, life story and interests, ancillary charges (e.g., charges for guest meals), hospital stays; and

Labels used for mailing bills or notices of meetings with family members.

The user devices 112, the PDA's 120 and the central system 106 may be programmed with suitable software to perform some or all of the functions described herein, including the functions described with reference to FIGS. 3-8. It is well within the capabilities of those who are skilled in the art to provide such software based on the disclosure hereof.

The order in which steps are shown to be performed in the drawings is only exemplary, and it is contemplated to change the order of the steps in any manner that is practical.

It is further contemplated that any one or more of the features disclosed herein may be employed alone or in combination with any one or more of the other features disclosed herein. Although FIG. 1 illustrates the invention in terms of a distributed system, it is alternatively contemplated that at least some of the features disclosed herein may be implemented in a system that serves only one residence facility. In such a case, a server on which the system is based may, but need not, be located at the residence facility. Even in the case of the distributed system shown in FIG. 1, the central system 106 may be located at one of the residence facilities that it serves.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of storing accession data, comprising:
performing a task relative to a resident;
entering accession data concerning the task into a handheld data device; and
transferring the accession data from the handheld data device to a resident information storage system.

2. The method of claim 1, further comprising:
associating a time stamp with the accession data at a time of the entering of the accession data.

3. The method of claim 2, wherein the transferring includes transferring the time stamp to the resident information storage system.

4. The method of claim 3, further comprising:
storing the accession data and the time stamp in the resident information storage system.

5. The method of claim 4, wherein the transferring includes communicating a device identifier to the resident information storage system, the device identifier identifying the handheld data device.

6. The method of claim 5, further comprising:
associating a person identifier with the stored accession data on the basis of the device identifier, the person identifier identifying a person who performed the task.

7. The method of claim 4, wherein the transferring includes communicating a person identifier to the resident information storage system, the person identifier identifying a person who performed the task.

8. A handheld data device configured to:
receive accession data concerning a task performed relative to a resident; and
transfer the accession data to a resident information storage system.

9. The handheld data device of claim 8, further configured to:
associate a time stamp with the accession data at a time of receiving the accession data.

10. The handheld data device of claim 9, further configured to:
transfer the time stamp to the resident information storage system.

11. A handheld data device configured to:
receive assessment data;
generate a care needs assessment based on the assessment data; and
generate billing information on the basis of the care needs assessment.

12. The handheld device of claim 11, configured to generate the billing information substantially immediately after receiving the assessment data.

13. The handheld device of claim 11, wherein the assessment data includes a number of medications prescribed for a resident.

14. The handheld device of claim 11, wherein the assessment data includes a health characteristic of a resident.

15. The handheld device of claim 11, further configured to transfer the assessment data to a resident information storage system.

16. A method comprising:
entering assessment data into a handheld data device; and
using the handheld data device to display billing information that is based on the assessment data.

17. The method of claim 16, wherein the billing information is displayed substantially immediately after the assessment data is entered.

18. The method of claim 16, wherein the assessment data includes a number of medications prescribed for a resident.

19. The method of claim 16, wherein the assessment data includes a health characteristic of a resident.

20. The method of claim 16, further comprising:
transferring the assessment data from the handheld data device to a resident information storage system.

21. A method comprising:
storing a respective care needs assessment for each of a plurality of residents who reside in a residence facility; and
estimating a current revenue rate of the residence facility on the basis of the stored care needs assessments.

22. The method of claim 21, further comprising:
storing for each of the plurality of residents assessment data upon which the respective care needs assessment is based.

23. The method of claim 21, further comprising:
storing a care level for each of the plurality of residents.

24. An apparatus, comprising:
a processor; and
a storage device in communication with said processor and storing instructions adapted to be executed by said processor to:
store a respective care needs assessment for each of a plurality of residents who reside in a residence facility; and
estimate a current revenue rate of the residence facility on the basis of the stored care needs assessments.

25. A method comprising:
storing assessment data relative to a resident, the assessment data having an assessment date associated therewith; and
automatically displaying a reminder to reassess the resident, the reminder being displayed on a reminder date determined based on the assessment date.

26. The method of claim 25, wherein the reminder date is substantially 90 days after the assessment date.

27. The method of claim 25, wherein the reminder date is substantially 30 days after the assessment date.

28. The method of claim 25, wherein the reminder is displayed in a pop-up window on a computer display.

29. An apparatus, comprising:
a processor; and
a storage device in communication with said processor and storing instructions adapted to be executed by said processor to:
store assessment data relative to a resident, the assessment data having an assessment date associated therewith; and
automatically display a reminder to reassess the resident, the reminder being displayed on a reminder date determined based on the assessment date.

30. An apparatus comprising:
a central system, including a processor and a storage device in communication with said processor, the storage device storing a database;
at least one first computer located at a first residence facility that is remote from the central system, the at least one first computer configured to transmit resident information to the database and to retrieve resident information from the database; and
at least one second computer located at a second residence facility that is remote from the central system and from the first residence facility, the at least one second computer configured to transmit resident information to the database and to retrieve resident information from the database.

31. The apparatus of claim 30, wherein:
the resident information transmitted and retrieved by the at least one first computer includes assessment information relating to care needs assessments for residents who reside in the first residence facility; and
the resident information transmitted and retrieved by the at least one second computer includes assessment information relating to care needs assessments for residents who reside in the second residence facility.

32. The apparatus of claim 30, wherein:
the resident information transmitted and retrieved by the at least one first computer includes contact information for at least one of family, friends and physicians of residents who reside in the first residence facility; and
the resident information transmitted and retrieved by the at least one second computer includes contact information for at least one of family, friends and physicians of residents who reside in the second residence facility.

33. The apparatus of claim 30, wherein:
the resident information transmitted and retrieved by the at least one first computer includes information concerning life histories of residents who reside in the first residence facility; and
the resident information transmitted and retrieved by the at least one second computer includes information concerning life histories of residents who reside in the second residence facility.

34. A method comprising:
transmitting resident information to a database from a first computer located at a first residence facility that is remote from the database;
using the first computer to retrieve resident information from the database;
transmitting resident information to the database from a second computer located at a second residence facility that is remote from the database and from the first residence facility; and
using the second computer to retrieve resident information from the database.

35. The method of claim 34, wherein:
the resident information transmitted and retrieved by the first computer includes assessment information relating to care needs assessments for residents who reside in the first residence facility; and
the resident information transmitted and retrieved by the second computer includes assessment information relating to care needs assessments for residents who reside in the second residence facility.

36. The method of claim 34, wherein:
the resident information transmitted and retrieved by the first computer includes contact information for at least one of family, friends and physicians of residents who reside in the first residence facility; and
the resident information transmitted and retrieved by the second computer includes contact information for at least one of family, friends and physicians of residents who reside in the second residence facility.

37. The method of claim 34, wherein:
the resident information transmitted and retrieved by the first computer includes information concerning life histories of residents who reside in the first residence facility; and
the resident information transmitted and retrieved by the second computer includes information concerning life histories of residents who reside in the second residence facility.

38. A method comprising:
receiving data entries which represent at least one of a life history of a resident and one or more interests of the resident, at least some of the data entries being indicated by selection of respective menu items; and
storing data which represents the received data entries.

39. The method of claim 38, further comprising:
generating an activity calendar for the resident based at least in part on the stored data.

40. The method of claim 38, wherein the menu items include professions.

41. The method of claim 38, wherein the menu items include areas of interest.

42. An apparatus, comprising:
a processor; and
a storage device in communication with said processor and storing instructions adapted to be executed by said processor to:
receive data entries which represent at least one of a life history of a resident and one or more interests of the resident, at least some of the data entries being indicated by selection of respective menu items; and
store data which represents the received data entries.

43. A method comprising:
receiving data entries which represent at least one of a life history and one or more interests with respect to each of a plurality of residents, at least some of the data entries being indicated by selection of respective menu items;
storing data which represents the received data entries; and
generating an activity calendar for a residence facility in which the residents reside based at least in part on the stored data.

44. The method of claim 43, wherein the menu items include professions.

45. The method of claim 43, wherein the menu items include areas of interest.

46. An apparatus, comprising:
a processor; and
a storage device in communication with said processor and storing instructions adapted to be executed by said processor to:
receive data entries which represent at least one of a life history and one or more interests with respect to each of a plurality of residents, at least some of the data entries being indicated by selection of respective menu items;
store data which represents the received data entries; and
generate an activity calendar for a residence facility in which the residents reside based at least in part on the stored data.
